(19) United States
(12) Patent Application Publication
(10) Pub. No.: US 2015/0261681 A1
(43) Pub. Date: Sep. 17, 2015

(54) HOST BRIDGE WITH CACHE HINTS

(71) Applicant: International Business Machines Corporation, Armonk, NY (US)

(72) Inventors: David F. Craddock, New Paltz, NY (US); Thomas A. Gregg, Highland, NY (US); Eric N. Lais, Tillson, NY (US)

(73) Assignee: International Business Machines Corporation, Armonk, NY (US)

(21) Appl. No.: 14/211,518

(22) Filed: Mar. 14, 2014

(51) Int. Cl. G06F 12/08

(52) U.S. Cl. CPC G06F 12/0875; G06F 12/0811; G06F 2212/452; G06F 2212/283

(57) ABSTRACT

Embodiments relate to an implementation of system memory to which a peripheral component interface (PCI) adapter is coupled via a host bridge. Cache hint controls are defined in a packet header for a memory request. The cache hint controls are configured to issue an instruction to retain a copy of a memory element in a cache structure.

### BACKGROUND

The present invention relates generally to processor input/output (I/O) interfacing within a computing environment, and more specifically, to processor input/output (I/O) interfacing within a computing environment in which a host bridge includes cache hints.

A computing environment may include one or more types of input/output devices, including various types of adapters. One type of adapter that may be included is a peripheral component interconnect (PCI) or peripheral component interconnect express (PCIe) adapter. The adapter uses a common, industry standard bus-level and link-level protocol for communication. However, its instruction-level protocol is vendor specific.

Communication between the devices and the system requires certain initialization and the establishment of particular data structures.

### SUMMARY

Embodiments include a method, system, and computer program product for implementation of system memory to which a peripheral component interface (PCI) adapter is coupled via a host bridge. Cache hint controls are defined in a packet header for a memory request. The cache hint controls are configured to issue an instruction to retain a copy of a memory element in a cache structure.

### BRIEF DESCRIPTION OF THE SEVERAL VIEWS OF THE DRAWINGS

The subject matter which is regarded as embodiments is particularly pointed out and distinctly claimed in the claims at the conclusion of the specification. The forgoing and other features, and advantages of the embodiments are apparent from the following detailed description taken in conjunction with the accompanying drawings in which:

FIG. 1 depicts a block diagram of a computer system implementing PCIe adapters in an exemplary embodiment;

FIG. 2 is a schematic diagram of a device table entry in accordance with embodiments;

FIG. 3 is a flow diagram illustrating maintenance of DTE error states and synchronizations in accordance with embodiments;

FIG. 4 depicts a block diagram of a computer system implementing host bridge cache hints in an exemplary embodiment; and

FIG. 5 depicts one embodiment of a computer program product incorporating one or more aspects of the present embodiments.

### DETAILED DESCRIPTION

Mechanisms are provided for expanding the size of a device table in system memory of a computing system in which multiple adapters are coupled to the system memory. The size of the device table may be increased to about 64,000 entries. The device table includes access control address translation information and interruption information to convert message signal interrupts to interrupts that other components understand while maintaining performance by way of a device table cache in each host bridge.

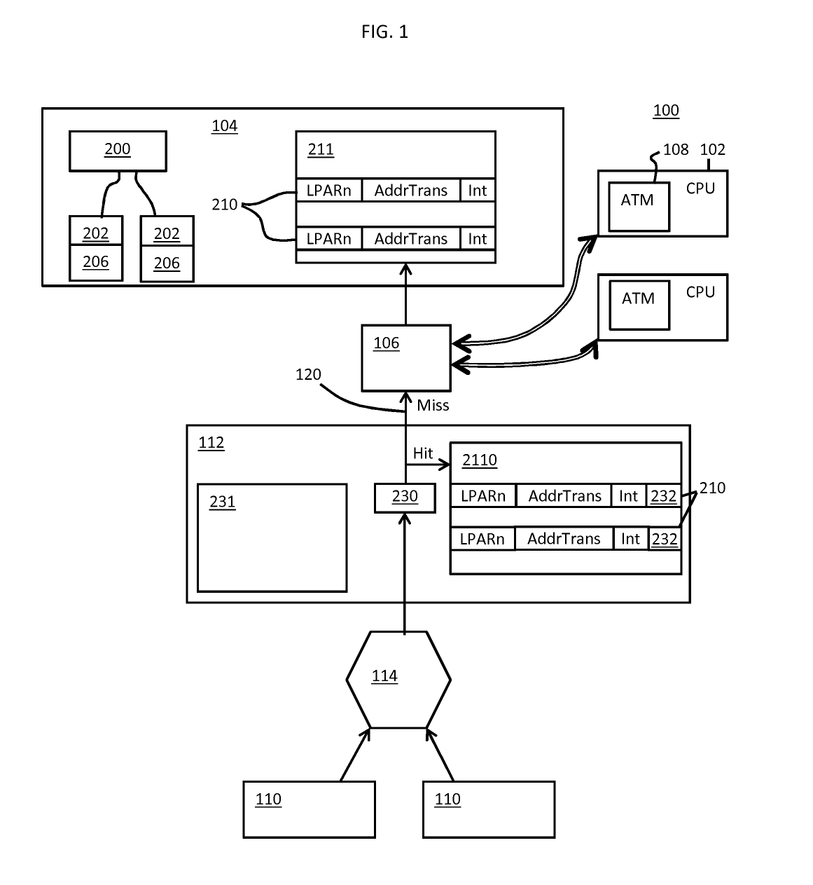

One exemplary embodiment of a computing environment to incorporate and use one or more aspects of the following is described with reference to FIG. 1. In one example, a computing environment 100 is a System Z® server offered by International Business Machines Corporation. System z is based on the z/Architecture® offered by International Business Machines Corporation. Details regarding the z/Architecture® are described in an IBM® publication entitled, “z/Architecture Principles of Operation,” IBM Publication No. SA22-7832-07, February 2009, which is hereby incorporated herein by reference in its entirety. IBM®, System z and z/Architecture are registered trademarks of International Business Machines Corporation, Armonk, N.Y. Other names used herein may be registered trademarks, trademarks or product names of International Business Machines Corporation or other companies.

The computing environment 100 has been described in detail in various patents and patent applications including U.S. Pat. No. 6,650,337, which was filed on Jun. 23, 2010, U.S. Pat. No. 6,645,767, which was filed on Jun. 23, 2010, U.S. Patent Application No. 2011/0320861, which was filed on Jan. 23, 2010, U.S. Patent Application No. 2011/0320772, which was filed on Jan. 23, 2010, U.S. Patent Application No. 2011/0320758, which was filed on Jan. 23, 2010 and U.S. Patent Application No. 2007/0168643, which was filed on Jan. 16, 2007. The disclosures of each of these are incorporated herein by reference.

In an exemplary embodiment, computing environment 100 includes one or more central processing units (CPUs) 102 or computer processors coupled to a system memory 104 via a memory controller 106. To access the system memory 104, one of the CPUs 102 issues a read or write request that includes an address used to access the system memory 104. The address included in the request is typically not directly usable to access the system memory 104, and therefore, it is translated to an address that is directly usable in accessing the system memory 104. The address is translated via an address translation mechanism (ATM) 108, as shown in FIG. 1. For example, the address may be translated from a virtual address to a real or absolute address using, for instance, dynamic address translation (DAT).

The request, including the translated address, is received by the memory controller 106. In an exemplary embodiment, the memory controller 106 includes hardware and is used to arbitrate for access to the system memory 104 and to maintain consistency of the system memory 104. This arbitration is performed for requests received from the CPUs 102, as well as for requests received from one or more adapters 110. Similar to the CPUs 102, the adapters 110 may issue requests to the system memory 104 to gain access to the system memory 104.

In an exemplary embodiment, at least one or more of the adapters 110 is a peripheral component interface (PCI) or PCI express (PCIe) adapter that may contain one or more PCIe functions. A PCIe function issues a request that requires access to the system memory 104. The request is routed to a host bridge 112 (e.g., a PCI host bridge) via one or more switches (e.g., PCIe switches) 114. In one exemplary embodiment, the host bridge 112 includes hardware, including one or more state machines, and logic circuits for performing scalable I/O adapter address translation and protection and function level error detection, isolation and reporting.

The host bridge 112 includes, for instance, a root complex that receives the request from the switch 114. The request includes an input/output (I/O) address that may need to be translated and the host bridge 112 provides the address to an address translation and protection unit (ATP Unit). The ATP Unit is, for instance, a hardware unit used to translate, if needed, the I/O address to an address directly usable to access the system memory 104, as described in further detail below. The request initiated from one of the adapters 110, including the address (translated or initial address, if translation is not needed), is provided to the memory controller 106 via, for instance, an I/O-to-memory bus 120 (also referred to herein as an I/O bus). The memory controller 106 performs its arbitration and forwards the request with the address to the system memory 104 at the appropriate time.

The system memory 104 may include one or more address spaces (or direct memory access (DMA) address spaces) 200. The DMA address space 200 refers to a particular portion of the system memory 104 that has been assigned to a particular component of the computing environment 100, such as one of the PCI functions contained in adapters 110. The address space 200 may be accessible by DMA initiated by one of the adapters 110 and may be referred to as a direct memory access (DMA) address space 200.

The system memory 104 may also include address translation tables 202 used to translate an address from one that is not directly usable for accessing the system memory 104 to one that is directly usable. There may be one or more address translation tables 202 assigned to the DMA address space 200 and each one may be configured based on, for instance, the size of the address space to which they are assigned, the size of the address translation tables 202 themselves and/or the size of the page (or other unit of memory) to be accessed.

In an exemplary embodiment, a hierarchy of address translation tables 202 may include a first-level table (e.g., a segment table), to which an input/output address translation pointer (i.e., the IOAT pointer field 215, to be described below) is directed, and a second, lower level table (e.g., a page table), to which an entry of the first-level table is pointed. One or more bits of a received PCIe address, which is received from one of the adapters 110, may be used to index into the corresponding first-level table 202 to locate a particular entry 206, which indicates the corresponding second-level table 202. One or more other bits of the PCIe address may then be used to locate a particular entry 206 in the second-level table 202. The entry 206 provides the address used to locate the correct page where the request is assigned and additional bits in the PCIe address may be used to locate a particular location in the page to perform a data transfer.

An operating system running on the computing environment 100 may be configured to assign the DMA address space 200 to one of the PCI functions of the adapters 110. This assignment may be performed via a registration process, which causes an initialization (via, e.g., trusted software) of a device table entry (DTE) 210 for the PCI function of a corresponding one of the adapters 110. The DTE 210 may be located in one or both of a device table 211 located in the system memory 104 and a device table cache 2110 located in the host bridge 112. In an exemplary embodiment, the device table cache 2110 may be located within the ATP Unit of the host bridge 112.

In accordance with a further embodiment, the device table 211 in the system memory 104 may have about 64,000 DTEs as compared to the 64 DTEs of the device table cache 2110 of the host bridge 112. More generally, the device table 211 may be about 3 orders of magnitude larger than the device table cache 2110. The DTEs of the device table cache 2110 relate to active I/O operations in progress.

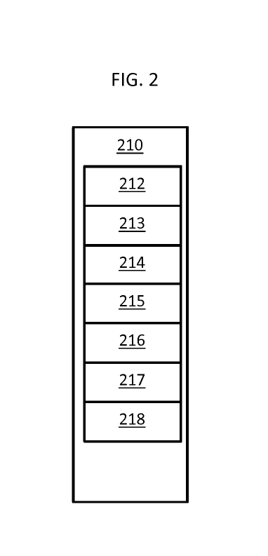

With reference to FIGS. 1 and 2 and, in accordance with an exemplary embodiment, each DTE 210 may be divided into an LPARn section, which indicates which logical partition (LPAR) the DTE is associated with, an AddrTrans section, which provides address translation information for a given request, and an Int section, which describes interrupt action instructions. More particularly, as shown in FIG. 2, each DTE 210 may include a number of fields, such as a format field (FMT) 212, which indicates the format of an upper level table of the address translation tables 202 (e.g., in the example above, the first-level table 202), PCIe base address (PCI Base @) 213 and PCI limit 214 fields that respectively provide a range used to define the DMA address space 200 and verify that a received address (e.g., the PCIe address) is valid and an IOAT pointer field 215, which is a pointer to the highest level of one of the DMA address translation tables 202 (e.g. first-level table 202). In addition, the DTE 210 may contain information related to converting Message Signaled Interruptions (MSI) to interrupts that may be interpreted by the system. For example, the device table entry 210 may include an interrupt control field 216, an interrupt vector address field 217 and a summary vector address field 218.

In an exemplary embodiment, the DTE 210 of the system memory 104 is located using a requestor identifier (RID) located in a portion of a given request issued by or in accordance with a PCI function associated with one of the adapters 110 (and/or by a portion of the PCI address). The RID (e.g., a 16-bit value that includes a bus number, device number and function number) is included in the request along with the PCIe address (e.g., a 64-bit PCIe address) to be used to access the system memory 104. The request, including the RID and I/O address, is provided to a contents addressable memory (CAM) 230 via the switch 114, which is used to provide an index value. The output of the CAM 230 is used to locate an entry in the device table cache 2110 and the device table entry 210. If the DTE 210 corresponding to the PCI function is not present in the device table cache 2110, then the RID may be used as an index to directly access the DTE 210 in the device table 211 in system memory 104.

In an exemplary embodiment, fields within the device table entry 210 are used to ensure the validity of the PCIe address and the configuration of the address translation tables 202. For example, the inbound address in the request is checked by the hardware of the I/O hub 112 to ensure that it is within the bounds defined by PCI base address 213 and the PCI limit 214 stored in the device table entry 210 located using the RID or a portion of the PCI address of the request that provided the address. This ensures that the address is within the range previously registered and for which the address translation tables 202 are validly configured.

With the configuration described above, the operating system running on the computing environment 100 may be configured to execute an access instruction, a manage instruction and a count instruction. The access instruction serves to indicate that the device table 211 in the system memory 104 is to be accessed by the host bridge 112 as requested by the PCI function via the switch 114, which is coupled to the adapters 110, as described above using a PCI e Bus/Dev/Func as an index.

The manage instruction serves as an indicator that the device table entry (DTE) cache 2110 of the host bridge 112 is to be accessed for any DMA read/write operation initiated by the adapter 110 or the PCI function and is to be managed in the host bridge 112 for coherency for DTE configuration changes. That is, for operations that are actively in progress or may be expected to become active, the request may be identified in the host bridge 112 as a hit in a given one of the DTEs 210 in the device table cache 2110. In this case, the request may be directed to the appropriate section of the DMA address space 200 without accessing the device table 211 in the system memory 104 and, as such, a response time for the request may be reduced as compared to the response time of a request proceeding to the device table 211. By contrast, where the request is identified as a miss relative to the DTEs 210 in the device table cache 2110, the request proceeds to the device table 211 in the system memory 104.

The count instruction serves as an indicator that a usage count, which is based on DMA read/write requests issued by one or more PCI functions, and an in-use count, which is related to indicating that there are address translation operations pending for a given PCI function, are each to be maintained in the host bridge 112 for each cached DTE 210. The count instruction thus serves to prevent a DTE 210 from being flushed from the device table cache 2110 while the address translation operations are in progress.

The number of DTEs in the device table cache 2110 may be limited to about 64, or whatever is reasonable for a hardware implementation. This number of entries is generally optimized for mainline PCI operations. That is, the device table cache 2110 is intended to be accessed and used only by mainline operations and its size is optimized based on the number of PCI functions supported and the typical usage patterns.

The device table cache 2110 is managed for DTE configuration changes by firmware running on the computing environment 100 based on usage by the operating system but direct updates to the device table cache 2110 are completed by hardware. In an exemplary embodiment, the operating system may issue one or more instructions requesting configuration changes, such as to re-register address translation or interruption parameters for a PCI function of an adapter 110 or to obtain a copy of operational parameters specific to a PCI function of an adapter 110. These instructions are referred to as modify PCI function controls (MPCIFC) instructions and store PCI function controls (SPCIFC) instructions, respectively, and are executed by one or more of the CPUs 102. The MPCIFC and SPCIFC instructions are specific to the I/O infrastructure (i.e., the infrastructure illustrated in FIGS. 1 and 2).

For a PCI instruction, such as an MPCIFC instruction, a DTE 210 in the device table 211 in the system memory 104 is updated and a corresponding DTE 210 in the DTE cache 2110 in the host bridge 112 is flushed in synchronization with the PCI instruction to prevent an obsolete copy of the DTE 210 being used by the host bridge 112. To this end, a least recently used (LRU) policy for the DTEs 210 in the device table cache 2110 is not in effect. In accordance with embodiments, a call logical processor (CLP) enable action may be taken in which an input/output processor (IOP) in the host bridge 112 or the I/O-to-memory bus 120 sets an enable condition in a corresponding one of the DTEs 210 in the device table 210 in the system memory 104 and issues a purge command with respect to the device table cache 2110. An MPCIFC register address translation (AT/Intrpt) condition may be set in which firmware sets parameters in the DTEs 210 in the device table cache 2110 in a given architected order and issues a purge device table cache 2110 command, an MPCIFC unregister address interruption (AT/Intrpts) condition may be set in which the firmware clears parameters in the DTEs 210 in the device table cache 2110 in the given architected order and issues the purge device table cache 2110 command, an MPCIFC reset error bit(s) action may be taken in which the firmware clears error bits and issues the purge device table cache 2110 command, an MPCIFC set interruption condition may be set in which the device table cache 2110 is purged if the interrupt control field 216 in the device table 211 is changed and a CLP disable condition may be set in which the IOP clears the DTEs 210 in the device table cache 2110 in the given architected order and issues the purge device table cache 2110 command. Thus, it may be understood that firmware always purges the device table cache 2110 after updating the DTEs 210 in device table 211 in system memory 104, to prevent the host bridge 112 from using an obsolete DTE 210.

With reference back to FIG. 1, the host bridge 112 may include one or more usage counters 231. Each usage counter 231 is associated with a given PCI function and a corresponding DTE 210. That is, a counter index is provided for each DTE 210 so that the counters can be selectively associated with one or more DTEs 210 with particular counters being associated with a single DTE 210 to provide counts on a PCI function basis or with particular counters being associated with DTE groups (e.g., all virtual functions (VFs) for a single adapter could be grouped to provide a single count per adapter 110). These usage counters 231 are incremented by the host bridge 112 as each DMA read or write request is processed and gives a measure of the activity for each PCI function or group of PCI functions.

An in-use count 232 in a given DTE 210 is incremented when an address translation (AT) fetch is issued and is decremented when the AT fetch is returned. The flushing of the given DTE 210 from the device table cache 2110 can thus only occur after all AT processing associated with that DTE 210 has completed. That is, the in-use count must be zeroes before the DTE 210 can be discarded and replaced by a new entry with respect to the device table cache 2110.

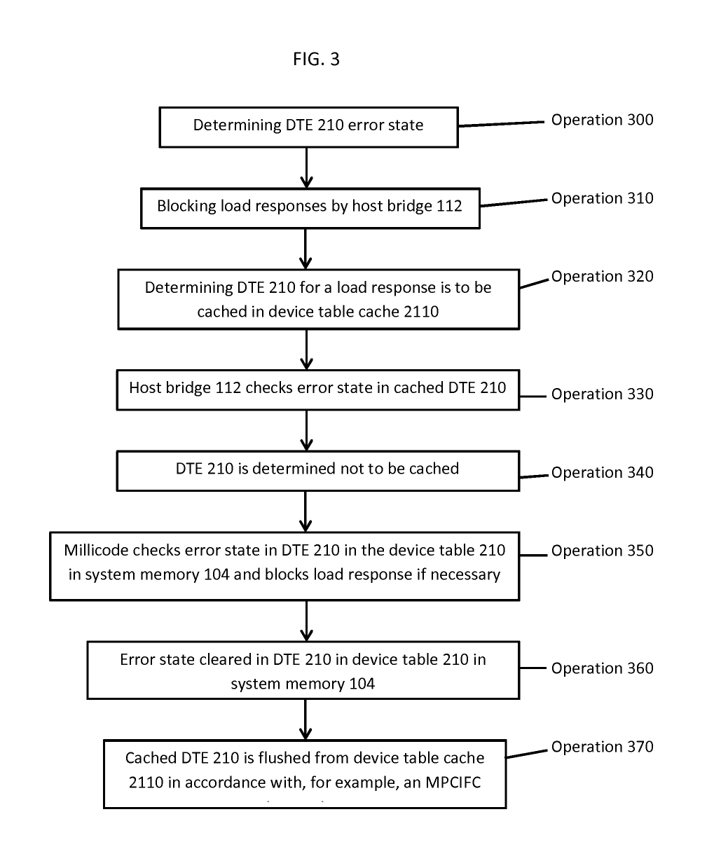

Mechanisms for maintaining DTE 210 error state and synchronization between software and hardware elements will now be described with reference to FIG. 3. As shown in FIG. 3, with a DTE 210 provided in the device table 211 in the system memory 104 and a copy of the DTE 210 in the device table cache 2110, error state bits are updated by hardware of the host bridge 112 both in the cached copy and also in the system memory 104. When an error is detected as part of address translation or interruption processing, the DTE 210 is put into the error state, by setting the error state bits in both the DTE 210 in system memory 104 and in the cached copy, such that future accesses can be blocked by the host bridge 112, and thus avoid data integrity issues. For subsequent DMA read or write requests, the host bridge 112 can block these accesses if the error state bit is set in the cached copy (or fetched from the DTE 210 in system memory 104).

For load response handling operations, where a DTE 210 is determined to be in an error state (operation 300), all load responses must be blocked by the host bridge 112 (operation 310). Where the DTE 210 for a load response is determined to be cached in the device table cache 2110 (operation 320), the host bridge 112 may check the error state in the cached DTE 210 (operation 330). Where the DTE is determined to not be cached (operation 340), there is a potential deadlock and performance penalty for retrieving the DTE 210 from the system memory 104. However, this is avoided though a unique response to the firmware that issued the load instruction, so that the firmware can check the error state in the DTE 210 in the device table 210 in the system memory 104 and block the load response if necessary (operation 350). An error state is then cleared in the DTE 210 in the device table 210 in the system memory 104 (operation 360) and any cached DTE 210 is flushed from the device table cache 2110 in accordance with, for example, an MPCIFC instruction (operation 370).

Technical effects and benefits of the embodiments described above include the provision of a device table 211 in system memory 104 and a device table cache 2110 in a host bridge with the device table 210 having an expanded size as compared to a device table that would otherwise be placed in each and every host bridge attached to the system memory 104. The device table includes access control address translation information and interruption information to convert message signal interrupts to interrupts that other components understand while maintaining performance.

In accordance with additional or alternative aspects, memory access latency in an I/O subsystem 600 is achieved by providing hints 606, 607 for caching control structures, such as the above described DTEs 210, address translation (AT) elements and intersystem channel data address lists, etc., in an L3/L4 cache 605. The operating system running on the I/O subsystem 600 may be configured such that a PCIe function defines cache hint controls included in a PCIe packet header for posted memory write and memory read requests. In some cases, the host bridge 112 optionally conveys these hint bits to a nest through DMA memory write and read commands under control of enablement bits (“DMA read hint bits”) in the DTE 210 for the requesting PCI function. As will be described below, a given DMA read hint bit instructs the nest to retain a copy of the fetched control structures in the local L3 cache and/or the L4 cache with the attached host bridge 112 rather than not keeping a copy in the L3 cache. The DMA write hint bit further instructs the nest to put the control structures in the L3 cache rather than bypassing the L3 cache and sending the control structures to DRAM in the system memory 104.

It will be understood that the L3 cache maybe located on a same chip as the host bridge 112 in some cases and that the L4 cache is an optional feature in those or other cases. For purposes of this disclosure, the L3 cache and the L4 cache will be referred to collectively as the L3/L4 cache 605.

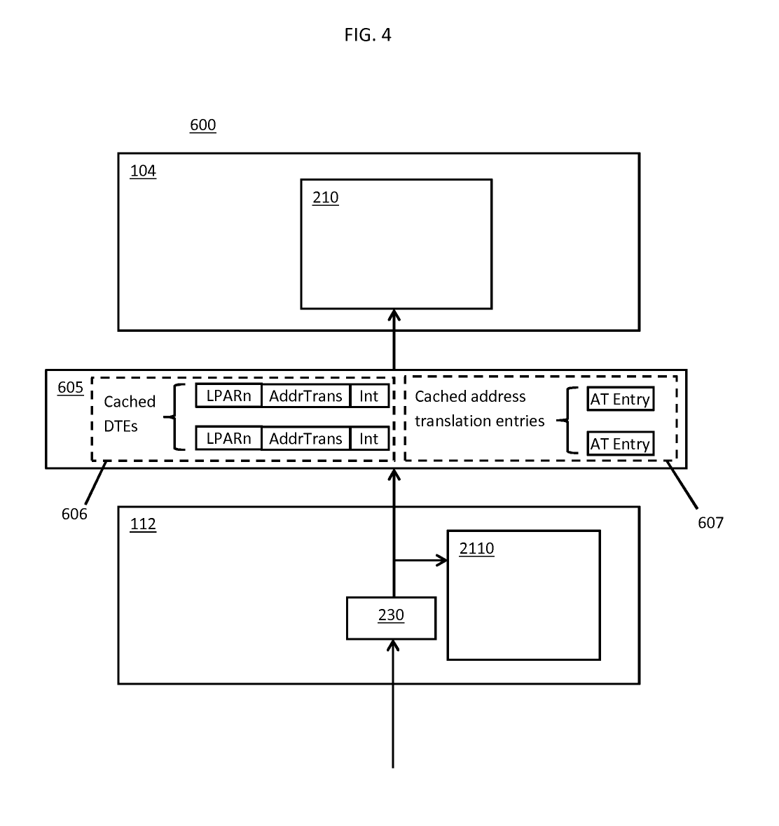

With reference to FIG. 4, the I/O subsystem 600 includes many of the features described above and a repetition of those descriptions will not be needed of provided. However, in an exemplary embodiment, the features of the I/O subsystem may include in a general sense the above-described system memory 104, the above-described device table 210 in the system memory 104, the above-described host bridge 112, the above-described CAM 230 and the above-described device table cache 2110.

In the case where a device table 211 is disposed in the system memory 104 in dynamic read access memory (DRAM), the host bridge 112 fetches DTEs 210 from among the 64,000 entries in the device table 211 as required and maintains them in the local device table cache 2110, which includes about 64 entries. As explained above, the host bridge 112 sometimes needs to discard the DTEs 210 in its device table cache 2110 when the device table cache 2110 fills up.

In such cases, since the DTEs 210 may not be written back into the system memory 104, a read-only DMA read cache hint bit 606 is used to tell the L3/L4 cache 605 to retain memory lines read from DRAM. Read-only hints 607 are also available for address translation elements and data address list elements. Thus, for structures that are cast out, the hints 606, 607 reduce latency on subsequent DMA reads.

Technical effects and benefits include the capability to reduce memory access latency in the I/O subsystem 600 by providing hints for caching control structures, such as the above described DTEs 210, address translation (AT) elements and intersystem channel data address lists, etc., in the L3/L4 cache 605.

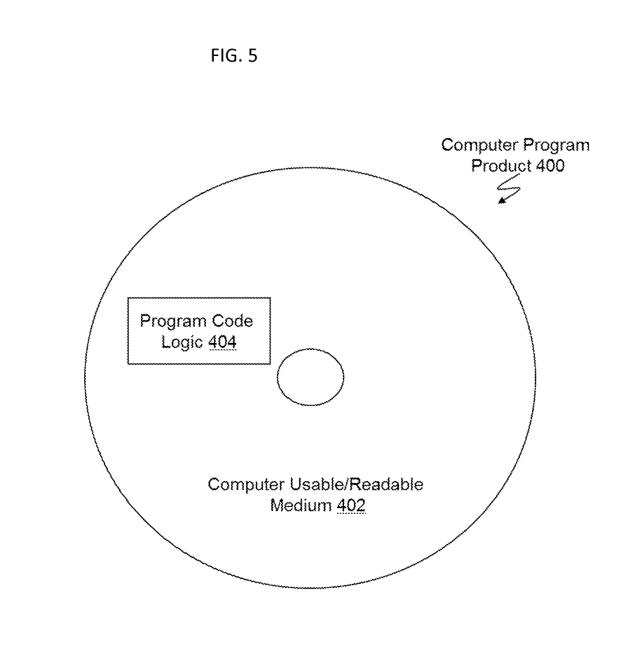

With reference to FIG. 5, the present invention may be a system, a method, and/or a computer program product 400. The computer program product 400 may include a computer readable storage medium 402 (or media) having computer readable program instructions 404 thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1-7. (canceled)

8. A computer program product for implementing system memory to which a peripheral component interface (PCI) adapter is coupled via a host bridge, the computer program product comprising:
a computer readable storage medium having program instructions embodied therewith, the program instructions readable by a processing circuit to cause the processing circuit to perform a method comprising:
defining cache hint controls in a packet header for a memory request; and
configuring the cache hint controls to issue an instruction to retain a copy of a memory element in a cache structure.

9. The computer program product according to claim 8, wherein the memory request comprises a memory write and memory read request and the memory element comprises a device table entry (DTE).

10. The computer program product according to claim 9, wherein the DTE is disposable in a device table in system memory and a device table cache in the host bridge,
the host bridge being configured to purge the DTE following retention of the copy of the DTE in the cache structure.

11. The computer program product according to claim 8, further comprising retaining the copy of the memory element in the cache structure.

12. The computer program product according to claim 11, wherein the cache structure comprises an L3/L4 cache.

13. A computer system for implementing system memory to which a peripheral component interface (PCI) adapter is coupled via a host bridge, the system comprising:
a memory having computer readable instructions; and
a processor configured to execute the computer readable instructions, the instructions comprising:
a definition of cache hint controls in a packet header for a memory request; and
a configuration of the cache hint controls to issue an instruction to retain a copy of a memory element in a cache structure.

14. The system according to claim 13, wherein the memory request comprises a memory write and memory read request.

15. The system according to claim 13, wherein the memory element comprises a device table entry (DTE).

16. The system according to claim 15, wherein the DTE is disposable in a device table in system memory and a device table cache in the host bridge.

17. The system according to claim 16, wherein the host bridge is configured to purge the DTE following retention of the copy of the DTE in the cache structure.

18. The system according to claim 13, wherein the memory element comprises at least one of an address table element and an intersystem channel data element.

19. The system according to claim 13, wherein the instructions further comprise a retention instruction for retaining the copy of the memory element in the cache structure.

20. The system according to claim 13, wherein the cache structure comprises an L3/L4 cache.
